(19) United States
(12) Patent Application Publication
(10) Pub. No.: US 2012/0266973 A1
(43) Pub. Date: Oct. 25, 2012

(54) Automatic basin temperature and level control

(76) Inventors: Ronald Gray, Spirit Lake, IA (US); Jerome Hamilton, Woodbury, MN (US)

(21) Appl. No.: 12/839,369

(22) Filed: Jul. 19, 2010

(51) Int. Cl. F16L 53/00; F16K 21/04

(52) U.S. Cl. 137/334

(57) ABSTRACT

A system and method for controlling the temperature and volume of a liquid entering a basin includes a microprocessor, a comparator, and a database. The system may include a control panel having buttons for establishing temperature and volume levels for water entering a bath. In one embodiment, the user uses a keypad to enter the desired temperature which is sent to a comparator. The system includes a temperature sensor to detect real-time temperature of the water entering a basin. The sensed real-time water temperature may also be sent to a comparator for controlling water control values to cease the inflow of water into the basin. The system also permits the user to store favorite volume settings for later use in filling the basin. In another embodiment the user communicates with the system to remotely establish a desired temperature value and basin volume fill level. In alternate embodiments, the system may be activated when the user using a mobile device is within a predetermined distance relative to the system.

### BACKGROUND OF THE INVENTION

1. Field of the Invention

This invention relates to a system and method for automatic control of the bathing temperature. Particularly, the invention relates to the management of bathing water temperature within safe bounds. More particularly, this invention relates to the automatic temperature setting and level control for residential and commercial bath and shower facilities.

2. Description of the Related Art

Current bath and shower systems require near continuous monitoring to properly regulate water temperature to the desired setting and fill a bathtub to the proper level prior to use.

Ordinarily, in traditional bath and shower systems the person desiring to control water temperature (the “user” herein) must adjust the water valve(s) to the proper position, wait some time for the water system to stabilize and deliver hot water, readjust water valve(s) to achieve the desired temperature, wait until the desired water level in the bathtub is achieved and then shut-off the water valves. All this interaction does not allow the user to easily perform other tasks. Additionally, if the user where to not monitor the water temperature and level, water and energy would be wasted and potentially in the case of a small hot water system all hot water could be exhausted with a delay required to reheat the system.

Interestingly, at least two prior art references are typical of prior attempts to address at least one aspect of the deficiencies noted above. That is, the references teach a system and method for controlling water temperature in a safe or desired temperature range. U.S. Pat. No. 4,420,811 to Tarnay et al., titled “Water temperature and flow rate selection display and control system and method” and U.S. Pat. No. 4,854,498 to Stayton, titled “Shower temperature control system” each profess to disclose a system and method for controlling and monitoring the temperature of a bath or shower. Tarnay, for example, suggests an Apparatus and method for selecting, displaying and automatically controlling water flow rates and temperatures at the outlets of devices used in plumbing fixtures such as sinks, bathtubs, showers, or lavatories. The apparatus of Tarnay includes a temperature sensor at the water output, a control panel for selecting desired output water temperatures and flow rates, a comparator for comparing the selected temperature to the output temperature, and for generating signals to control separate hot and cold water valves to achieve and automatically maintain, within limits, any desired combination of flow rate and temperature. In one embodiment Tarnay teaches that the comparator is embodied in a microprocessor which receives a digital signal representative of the actual water temperature, and generates a modified signal to adjust hot and cold water flow to the output means until the actual output temperature matches the selected temperature within a small error range while maintaining flow rate at a constant level.

Similarly, Stayton teaches a shower temperature control system that includes a single mixing valve connected between hot and cold sources of water and a shower head. The Stayton system also teaches a gear motor with a shaft connected to the mixing valve, a water temperature sensor positioned in the shower plumbing, a numeric keypad for numeric entry of desired shower water temperature, a potentiometer for alternate entry of desired shower temperature, and a controller which derives a motor drive signal from a difference between the sensed temperature and the set temperature. The controller incorporates memory for the storage of a plurality of preset shower water temperatures which may be selected by selection keys on the keypad.

However, neither Tarnay nor Stayton address the water conservation problem inherent in all prior art temperature control systems. Namely, neither reference teaches or suggests a system and method for automatically monitoring the volume of water dispensed during a water temperature monitoring step.

### SUMMARY OF THE INVENTION

In accordance with the present invention an automatic temperature setting and level control comprises a wall mounted electronic control system for temperature set point and display, a thermocouple for temperature measurement, motorized valve(s) and drain and a water level sensor.

In one aspect, the automatic basin temperature and water level control system and apparatus of the present invention quickly and automatically adjusts bath and/or shower water temperatures to the desired setting preferred by a user. The desired water temperature is reached without the user constantly monitoring or adjusting the water temperature.

In another aspect of the invention the automatic basin temperature and water level control system and apparatus of the present invention achieves an energy and water savings by minimizing the excess water volume required to fill a water basin at an predetermined temperature. The user pre-selects a desired water temperature and basin fill volume on the temperature and water control apparatus. Once the desired temperature is sensed by the temperature and water level control, the control automatically closes the basin drain permitting the basin to fill with the correctly temperatured water. In one embodiment, the temperature and water level control system and apparatus includes a water level sensor for measuring the volume of water in the basin. Once the appropriate water volume in the basin is measured, the temperature and water level control system and apparatus, aided by the water level sensor, signals the basin fill valves to terminate water flow. In yet another embodiment of the invention, the water level sensor is adjustable to a desired basin fill level.

As will be described below, the automatic temperature and water level control addresses the shortcomings in the prior art by freeing the user from the burden of monitoring the temperature and water volume of a water basin during the fill cycle. The invention permits the user to pre-select both water temperature and basin fill volume and the apparatus and system of the present invention fills the basin accordingly. Consequently, the user is free to multi-task after initiating a water temperature and basin fill cycle.

Further objects and advantages of the present invention are apparent from a consideration of the ensuing description and drawings.

### DRAWING FIGURES

A more complete understanding of the present invention may be derived by referring to the various embodiments of the invention described below in conjunction with the appended drawings and figures in which like numerals denote like elements, and in which:

FIG. 1 is a depiction of an exemplary embodiment of the automatic basin temperature and water level control system and apparatus in accordance with the present invention; and

FIG. 2 is an exemplary flow diagram of the operation of the automatic basin temperature and water level control system in accordance with an exemplary embodiment of the present invention.

### DETAILED DESCRIPTION OF AN EXEMPLARY EMBODIMENT

It should be appreciated that the particular implementations shown and described herein are illustrative of the invention and its best mode and are not intended to otherwise limit the scope of the present invention in any way. Indeed, for the sake of brevity, there will be limited discussion of the operation of convention faucets and valves with conventional hot and cold handles (or other control means) that are widely used to control output water temperature and flow rates for sinks, bathtubs and other plumbing related fixtures. To promote consistency in this description, the plumbing related fixtures such as sinks, bathtubs, basins will be referred to as “basin” or “basins,” although any plumbing related fixture suitable for temporarily or permanently holding dispensed water is contemplated, where the plumbing related fixture includes a drain for elimination of the water from the plumbing related fixture body.

Additionally, the conventional concepts of electronic signal, data processing, and thermal transducer, thermosensors, and thermocouple operation and the like will not be discussed herein. Further still conventional concepts of water or liquid level sensors, such as hydro water level sensors, hydro optical water level sensors, hydro acoustic sensors and other like liquid level sensors will also not be discussed in the interest of brevity. Moreover, while the invention is directed toward the control and measuring of water, the invention is not limited by liquid.

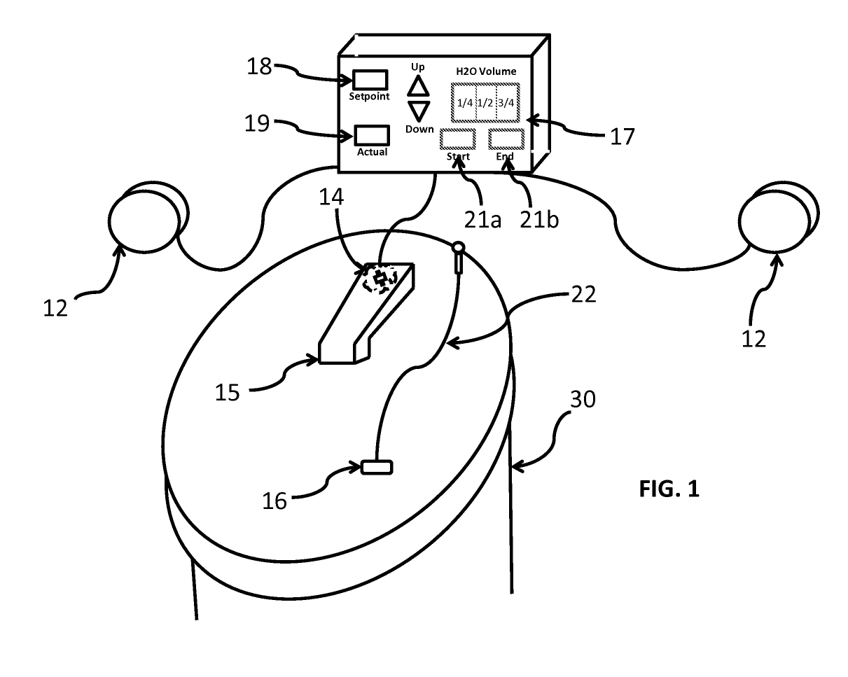

As shown in FIG. 1, an exemplary embodiment of the automatic basin water temperature and level control system and apparatus 1 according to the present invention comprises a control unit 10 configured to receive sensed data from a water temperature sensing unit 14 and a liquid volume sensing unit 16 and to control the hot and cold motorized water control valves 12 and automatic drain valve 13. The control unit 10 may be any control unit for receiving the sensed data and operating the hot and cold motorized water control valves 12 to ensure that the proper regulation of the hot and cold water is performed allowing the water dispensed from a discharge faucet to be dispensed at a predetermined temperature as desired by a system user. The control unit 10 may also be configured to control the automatic drain valve 13. For example, the control unit 10 may be configured to receive the water temperature data from the water temperature sensing unit 14 and to control the automatic drain valve 13 to trigger the valve 13 to close when the predetermined water temperature is reached. Additionally, the control unit 10 may receive a sensed basin water level (water volume) signal from the liquid volume sensing unit 16 and to operate the motorized water control valves 12 to cease the flow of the water into a basin 30 when the desired water volume in the basin 30 is reached. In one embodiment, the water temperature sensing unit 14 may be positioned such that the water filling the basin 30 may be sensed. In the embodiment shown, the water temperature sensing unit 14 is depicted in contact with the liquid being dispelled from the faucet interposed in a discharge faucet 15. In this manner the real-time temperature of the water can be sensed as the water is expelled from faucet 15 to fill basin 30. In other exemplary embodiments, the water temperature sensing unit 14 may be placed in any position relative to the water filling basin 30 for sensing the real-time temperature of the water filling basin 30.

Control unit 10 includes a user interface 17 for use by the user to preselect a desired water temperature level. In the exemplary embodiment shown, interface 17 includes an actual water temperature display 19 for displaying the real-time temperature of the water being dispensed into basin 30. Interface 17 further includes a setpoint display 18 for use in displaying the user preselected water temperature (“setpoint temperature”). In one instance, the setpoint temperature is the desired water temperature as determined by the user. The user may preselect a setpoint temperature using temperature control buttons 11a (the UP button) and 11b (the DOWN button), the operation of which is described more fully below. Further, user interface 17 may also include buttons for beginning (the START button 21a) and ending (the END button 21b) the basin filling sequence described herein.

It should be noted that exemplary embodiments of the invention may include conventional water or liquid level sensors and thermal or water temperature sensors as noted above. Additionally, the invention may include traditional means of receiving data from the water level and temperature sensors and converting that data to electrical signals or optical impulses for use by a microprocessor and database. Similarly, motorized control valves 12 may be any conventional control means for controlling liquid output, temperature and flow rates where such control means is responsive to commands and may operate without human intervention.

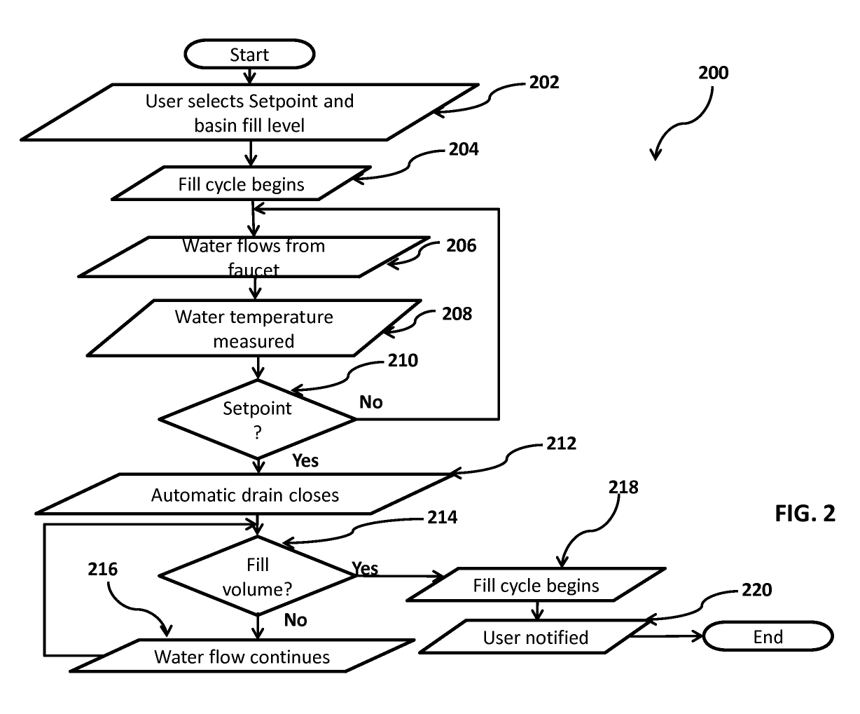

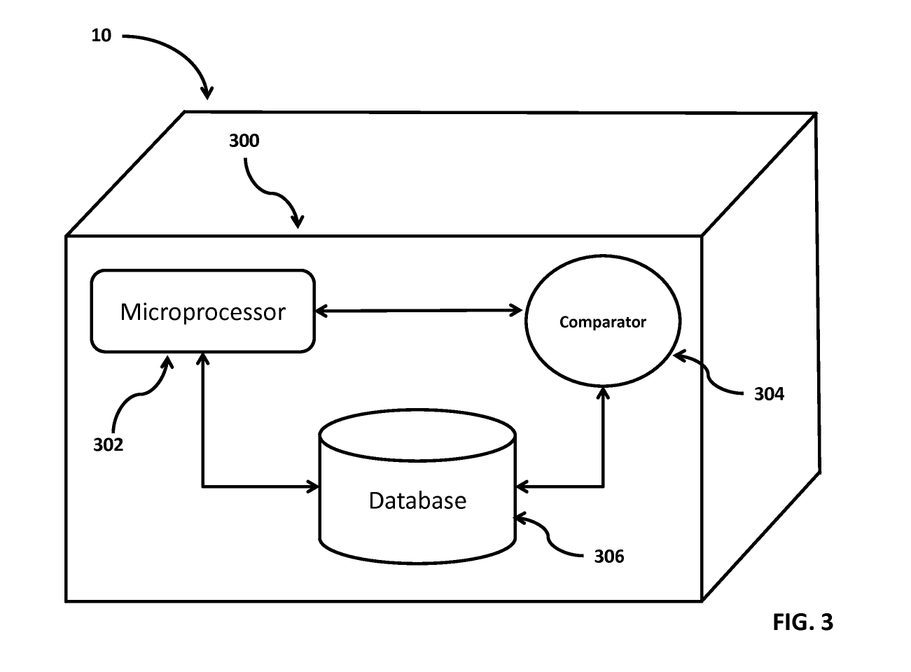

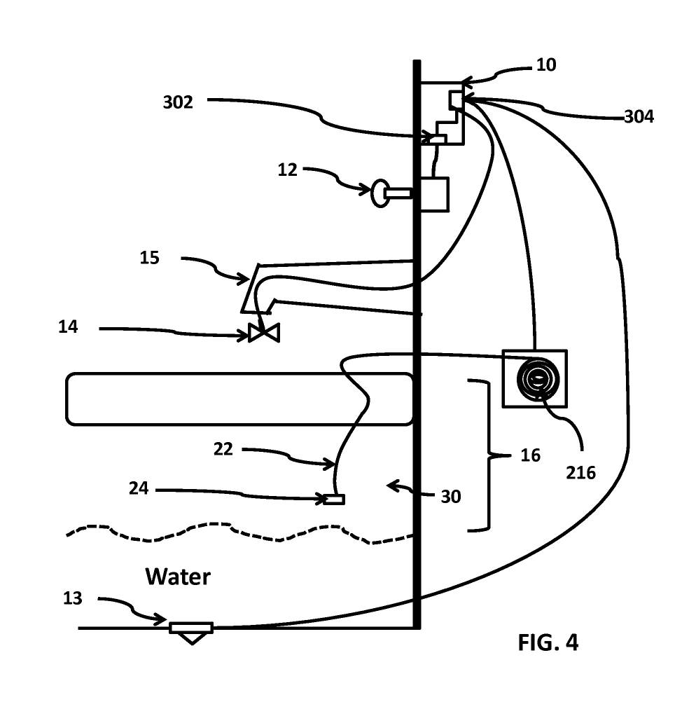

The operation of automatic basin water temperature and level control system and apparatus 1 may be best understood by reference to FIG. 1 and the exemplary method of operation flow diagram 200 of FIG. 2. As shown the operation of the apparatus 1 may begin with the user selecting a desired water temperature (e.g., “setpoint”) for the water filling basin 30 (Step 202). To select the setpoint, the user refers to user interface 17, and particularly to setpoint display 18. Setpoint display 18 may be any display capable of communicating translatable data to the user. In one exemplary embodiment, setpoint display may be a liquid crystal display, light emitting diode display, analog display, or the like. Preferably, setpoint display 18 is configured to display a numerical value to the user that corresponds to the temperature of the water the user desires to reach.

User interface 17 further includes setpoint temperature adjustment controls 11a (the UP button) and 11b (the DOWN button). Setpoint temperature adjustment controls 11a and 11b may be configured to adjust the image shown on setpoint display 18. Preferably, the adjustment controls 11a and 11b are configured such that they are operable to control the setpoint temperature the user desires. For example, in one embodiment, the user may desire to set the setpoint temperature higher than the temperature being shown on the setpoint display 18. In this instance, the user may engage control button 11a (the UP button) to raise the temperature being shown on setpoint display 18 to the desired setpoint. Similarly, where the user wishes to lower the temperature being shown on setpoint display 18, the user may engage control button 11b (the DOWN button) to lower the temperature being shown to the desired setpoint. In this manner, the user is able to set the desired setpoint temperature. The setpoint display 18 may then send a setpoint temperature signal to a comparator (not shown) included with the control unit 10.

In another embodiment of the invention, the user is also permitted to select basin 30 fill level. That is, the user may select the volume of water that will be filled in basin 30 at the end of the fill cycle (discussed below with respect to Step 218). In this embodiment, liquid volume sensing unit 16 is adjustable. For example, where liquid volume sensing unit 16 requires contact with the water level in basin 30 to detect basin 30 water volume, sensing unit 16 may be positioned on or in basin 30 to such that once the water level in basin 30 contacts the liquid volume sensing unit 16, sensing unit 16 sends a corresponding signal to control unit 10 indicating that the basin fill level has been reached. To facilitate the adjusting of the liquid volume sensing unit 16, the unit 16 may be in electrical communication with control unit 10 via for example a retractable cord 22. Retractable cord 22 may be a cord that is suitable for extending and locking at a desired length and which can also be retracted, wherein the cord 22 is capable of caring water level data to control unit 10.

Alternatively, where liquid volume sensing unit 16 is of the optical variety, sensing unit 16 may be placed anywhere on basin 30 permitting sensing unit 16 to optically measure basin 30 fill level.

Once the user selects the desired setpoint (and possibly the basin fill level), the user begins the basin 30 fill cycle (Step 204). The user may begin the fill cycle by engaging START button 21a. Once START button 21a is engaged, water control valves 12 operate to initiate the basin fill cycle. In one embodiment, the control valves 12 are motorized. Control valves 12 may be responsive to signals from the control 10 to engage to fill basin 30 or to cease filling basin 30. Upon beginning the fill cycle (Step 204), water fills basin 30 (Step 206).

The temperature of the water filling basin 30 is measured by water temperature sensing unit 14 (Step 208). In one embodiment water temperature sensing unit 14 may be thermocouple operable to send a signal to a control unit 10 microprocessor (not shown) that is indicative of the water's real-time temperature. The real-time water temperature signal may be sent to the comparator included with control unit 10. The comparator may take the real-time water temperature signal and the setpoint temperature signal and compare the signals to produce an error signal representative of the difference between the real-time water temperature signal and the setpoint temperature signal (the “difference signal”) (Step 210). Control unit 10 microprocessor operates in accordance to the difference signal to control water control valves 12. The microprocessor controls water control valves 12 to adjust toward the difference signal to a calibrated value. The calibrated value may be a value range within which the difference signal may be valued to ensuring the water entering the basin has reaching the setpoint temperature. In one embodiment, the difference signal may be zero or near zero indicating the real-time water temperature signal and the setpoint temperature signal are of equal value or near equal value.

If the difference signal IS NOT of a value for ensuring the water entering basin 30 is about the value of the setpoint temperature signal (or in an acceptable setpoint temperature signal range) the water temperature sensing unit 14 will continue to send real-time water temperature signals to the comparator. The comparator continues to compare the real-time water temperature signal and the setpoint temperature signal and provide the difference signal to control unit 10 microprocessor.

On the other hand, if the difference signal IS of a value for ensuring the water entering basin 30 is about the value of the setpoint temperature signal (or in an acceptable setpoint temperature signal range) the microprocessor sends a signal to automatic drain 13 to operate drain 13 to close preventing the water in the basin from exiting the basin 30 (Step 212). The water then begins to fill basin 30.

Once the water begins to fill basin 30, the liquid volume sensing unit 16 senses the water level (e.g., volume) in basin 30. Liquid volume sensing unit 16 detects the water level and provides a water level signal indicative of the water volume filling up basin 30 (Step 214). Water will continue to fill basin 30, until the desired volume of water is reached (Step 216). When the water level in basin 30 is of a desired volume, the control unit 10 microprocessor receives the water level signal and operates water control valves 12 cease the flow of water into basin 30, thereby ending the fill cycle (Step 218).

In alternate embodiments of the invention, the user may be notified that the fill cycle has ended (Step 220). For example, such notification may be an audible notification like a beep, pre-recorded voice notification, or a wireless notification like a wireless message or wireless call being placed to a mobile device like a phone, pager, PDF, or the like. In some embodiments, the user is permitted to select the form of notification. Thus, if a user is watching a favorite program on television, the user is able to select that the notification come through the television speakers or be flashed across the television screen.

Although the description above contains much specificity, these should note be construed as limiting the scope of the invention but merely providing illustrations of some of the presently preferred embodiments of this invention. The invention is best understood with respect to the attached claims and drawings along with the foregoing specification.

What is claimed is:

1. Automatic bath temperature and liquid level control system comprising:
a. liquid temperature sensing unit for detecting a real-time temperature of a liquid and generating a real-time liquid temperature signal corresponding said real-time temperature of said liquid;
b. a liquid volume sensing unit for detecting a volume of a liquid filling a container and generality a liquid volume signal corresponding 10 said volume;
c. a control unit including a setpoint temperature level setting unit, said setpoint temperature level unit producing a setpoint temperature level signal;
d. a comparator for receiving said setpoint temperature level signal and said real-time liquid temperature signal, compare said setpoint temperature level signal and said real-time liquid temperature signal, and produce a difference signal representative of the difference between said setpoint temperature level signal and said real-time liquid temperature signal;
e. an automatic liquid control valve for controlling the now of said liquid into said container, said automatic liquid control valve responsive to said difference signal;
f. an automatic drain configured for controlling the egress of said liquid from said container, said automatic drain responsive to said difference signal to prevent said liquid from exiting said container; and
g. a microprocessor, wherein said microprocessor receives said difference signal and controls said automatic drain valve when said real-time liquid temperature signal is substantially equal to said setpoint temperature signal.

2. A system of claim 1, wherein said microprocessor controls said automatic liquid control valve in accordance with said difference signal.

3. A system of claim 1, wherein said liquid volume sensing unit includes a thermocouple.

4. A system of claim 1 wherein said liquid volume sensing unit includes an optical sensor.

5. A system of claim 1, wherein said liquid volume sensing unit includes a sonic sensor.

6. A system of claim 1, wherein said liquid volume sensing unit includes a retractable liquid volume sensor.

7. A system of claim 1, further including a database for storing a preselected liquid volume level, said database for providing said preselected liquid volume to said microprocessor.

8. A system of claim 7, wherein said database stores a predetermined container volume.

9. A system of claim 8, further including is liquid now sensing unit for determining the volume of liquid entering said container and producing a liquid volume signal corresponding to the real-time volume of liquid in said container.

10. A system of claim 9, wherein said microprocessor retrieves said preselected liquid volume level, said predetermined container volume, and said liquid volume signal, said microprocessor configured to control said automatic liquid control valve to cease the now of said liquid into said container when a value of said liquid volume signal is substantially equal to said preselected liquid volume level.

11. A system of claim I, wherein said setpoint temperature level selling unit is controlled remotely using a remote control device operable to select a setpoint temperature level, said setpoint temperature level unit producing a setpoint temperature level signal.

12. A system of claim I, wherein a desired volume fill level is established for use in establishing a liquid volume level, said established liquid volume level for use by said microprocessor for producing a liquid volume fill level signal and providing said liquid volume fill level signal to said comparator.

13. A system of claim 12, wherein said desired volume fill level is established remotely.

14. A method of automatically controlling a bath temperature and liquid level comprising:
a. producing a setpoint temperature signal representing a desired liquid temperature:
b. measuring a real-time temperature of the liquid, producing a real-time temperature signal;
c. controlling an automatic liquid control valve to control the now of liquid into a basin, the control of the automatic liquid control valve being done in accordance with the difference between the setpoint temperature signal and said real-time temperature signal;
d. controlling an automatic drain to prevent the exiting of water from a container, the controlling of the automatic drain being done when the real-time temperature signal is substantially equal to the setpoint temperature signal;
e. measuring the volume of liquid in the container and producing a real-time liquid volume signal corresponding to the real-time volume of the liquid in the container; and
f. controlling the automatic liquid control valve to prevent liquid from filling the container in response to the liquid volume signal.

15. A method of automatically controlling a bath temperature and liquid level comprising:
a. producing a setpoint temperature signal representing a desired liquid temperature:
b. measuring a real•<time temperature of the liquid, producing a real-time temperature signal;
c. controlling an automatic liquid control valve to control the flow of liquid into a basin, the control of the automatic liquid control valve being done in accordance with the difference between the setpoint temperature signal and said real-time temperature signal;
d. controlling an automatic drain to prevent the exiting of water from a container, the controlling of the automatic drain being done when the real• time temperature signal is substantially equal to the setpoint temperature signal;
e. measuring the liquid flow volume entering the container;
f. comparing a predetermined container volume to the liquid flow volume measurement;
g. providing for the selection for a preselected liquid volume level; and
h. controlling the automatic liquid control valve to prevent liquid from filling the container when the liquid flow volume measurement is substantially equal to the preselected liquid volume level.

16. A method of claim 15, further including the step of storing a preselected liquid volume level in a database.

17. A method of claim 15, further including the step of storing a predetermined container volume in a database.
